(19) United States
(12) Patent Application Publication
(10) Pub. No.: US 2015/0120579 A1
(43) Pub. Date: Apr. 30, 2015

(54) REPAIR INFORMATION MANAGEMENT APPARATUS, REPAIR INFORMATION MANAGEMENT SYSTEM, AND REPAIR INFORMATION MANAGEMENT METHOD

(71) Applicant: FUJIFILM Corporation, Tokyo (JP)

(72) Inventor: Kazunari Toyama, Ashigarakami-gun (JP)

(21) Appl. No.: 14/525,001

(22) Filed: Oct. 27, 2014

(30) Foreign Application Priority Data
Oct. 29, 2013 (JP) 2013-224334

(51) Int. Cl. G06F 19/00

(52) U.S. Cl. CPC G06F 19/3412
USPC 705/305

(57) ABSTRACT

In a repair information management apparatus, a term correspondence table is stored in a database. In the term correspondence table, each term (word) to be displayed on a repair information input screen for inputting repair information is associated with country-specific terms, being translations of the term in two or more languages. In the repair information management apparatus, a term correspondence table updater is activated when an application server is activated in an edit mode. In response to its activation, the term correspondence table updater delivers an edit screen for editing the term correspondence table to a user terminal, and updates the term correspondence table based on editing performed through the edit screen on the user terminal.

### CROSS-REFERENCE TO RELATED APPLICATIONS

The present application claims priority under 35 U.S.C. §119 to Japanese Patent Application No. 2013-224334, filed Oct. 29, 2013. The above application is hereby expressly incorporated by reference, in its entirety, into the present application.

### BACKGROUND OF THE INVENTION

1. Field of the Invention

The present invention relates to a repair information management apparatus, a repair information management system, and a repair information management method, for managing repair information of medical equipment.

2. Description Related to the Prior Art

Repair information management systems for managing repair information of medical equipment are known, such as the one disclosed in Japanese Patent Laid-Open Publication No. 2002-015082. The disclosed repair information management system is a computer system which receives repair requests from users of the medical equipment, creates repair plans based on failure circumstances, and manages failure information. The repair information management system comprises intermediary center terminals and repair center terminals. The intermediary center terminal is disposed in an intermediary center that receives the repair requests from the users. The repair center terminal is disposed in a repair center where repairs are performed. The repair center terminal manages the repair information transmitted from the intermediary center. The intermediary center terminal is used for obtaining failure descriptions based on information provided by the user and creating repair plans. The created repair plans are transmitted to the user, and the repair plan selected by the user is transmitted to the repair center terminal. The repair center terminal manages information related to the repair.

With the increasing globalization of the world economy, medical equipment produced by a domestic manufacturer has been exported to many countries where different languages are used. Repair centers have been established in the countries importing the medical equipment, to repair the medical equipment in their countries. Since the repair information of the product includes a faulty part of the product and the failure description, the repair information is useful for the manufacturer in learning from a defect of the product to improve the product or develop a new product. It is desirable for the manufacturer to collect the repair information from each repair center in each country and collectively manage the collected repair information with the use of a repair information management system disclosed in the Japanese Patent Laid-Open Publication No. 2002-015082. In consideration of statistical processes of the collected repair information and global use of the collected repair information across many countries, it is preferred to use a single language (e.g. English, being a de-facto standard language) in the operation screen or input information of the repair information management system.

However, most of the repair centers in the importing countries are not directly managed by the manufacturer, but by local repair services. Naturally, repair staffs, who perform the repairs, are people locally hired. There are regional differences in prevalence of English and the English proficiency of the repair staffs varies with their language backgrounds. It is concerned that the unified use of English in the repair information management system may cause the repair staffs to make errors in operation or input of information, and lack of understanding repair procedures results in a decline in the repair quality, particularly in countries where English is not commonly used. To prevent such problems, so-called localization is necessary. The localization refers to processes of adapting the language used in the repair information management system to a language in a specific county or region.

The localization needs translation of terms (words) related to the repair information into the language of each country and registration of the translated terms in a database. The translation may be done by translators in the country exporting the medical equipment; however, the following problems may arise.

First, translating into many languages is cost and time-consuming. The translation of terms needs to be done constantly as new terms are added due to improvements of products or launching new products. In other words, the database of the terms needs to be updated constantly. The cost and time necessary for the translation may become significant. The number of the repair requests in one country depends on the number of the products sold in the country. A country with many repairs can afford high translation cost. However, a country with few repairs, in other words, a country with small sales, may not be able to afford the translation cost.

Second, it is preferred to select translated terms that best suit country-specific culture or the technical level of the repair staffs. As described above, it is extremely important to select the suitable translated terms because inappropriately translated terms may cause the repair staffs to make errors in operation or input, resulting in the decline in the repair quality. There are many translators specializing in a language spoken by many people, for example, English, so that a certain level of translation quality is ensured. However, ensuring translation quality of a language becomes increasingly difficult as the number of speakers of the language decreases. Moreover, many of the terms related to the repair of the medical equipment are specialized, unlike those related to commonly used products such as a TV or a radio. Thus, it is extremely difficult to translate the terms properly and avoid misleading translations. The Japanese Patent Laid-Open Publication No. 2002-015082 does not point out explicitly or suggest such problems and their solutions.

### SUMMARY OF THE INVENTION

An object of the present invention is to provide a repair information management apparatus, a repair information management system, and a repair information management method, capable of multilingual localization with less cost and time.

In order to achieve the above and other objects, the repair information management apparatus, according to the present invention, for managing repair information of medical equipment comprises an operation screen distributor, a term correspondence information storage, a registration request receiver, and a term correspondence information updater. The operation screen distributor distributes operation screens through a network to terminals located in countries where different languages are used. The repair information is inputted to and displayed on the operation screen. The term correspondence information storage stores a term correspondence information, which allows selecting one of languages used for inputting and displaying the repair information on the operation screen. A term related to the repair information is associated with country-specific terms in the term correspondence information. The country-specific terms are translations of the term related to the repair information in the languages. The registration request receiver receives a term registration request for registering a country-specific term in the term correspondence information from the terminal. The term correspondence information updater updates the term correspondence information based on the term registration request.

It is preferred that the repair information management apparatus further comprises a language determiner and an operation screen generator. Based on identification information transmitted from the terminal, the language determiner determines the language used on the operation screen. The operation screen generator consults the term correspondence information storage and generates the operation screen with the use of the country-specific terms corresponding to the determined language.

It is preferred that the repair information management apparatus further comprises a user language correspondence information storage for storing user language correspondence information, in which a user ID assigned to the user using the terminal is associated with a language ID indicating the language. The language determiner determines the language based on the user ID inputted as the identification information.

It is preferred that the repair information management apparatus further comprises a repair information receiver and a repair information storage. The repair information receiver receives the repair information through the network. The repair information is inputted through the operation screen of the terminal. The repair information storage stores the received repair information.

It is preferred that the repair information includes at least one of items: a faulty part, a failure description, a cause of a failure, and a repair description of the medical equipment.

It is preferred that each term is assigned a code, and the each term is associated with the country-specific terms and the code in the term correspondence information.

It is preferred that the repair information is a piece of information which includes each of the items: the faulty part, the failure description, the cause of the failure, and the repair description, and the each item is stored together with one of the codes.

It is preferred that the operation screen is provided with an item input box to which one of the items is inputted.

It is preferred that the repair information management apparatus further comprises a candidate storage and a refined search section. The candidate storage stores in advance the terms to be displayed as possible candidates for the item input boxes. The possible candidates of the different item input boxes are associated with each other in the candidate storage. The refined search section searches through the candidate storage with a search key, being the term inputted to one of the item input boxes, and narrows down the candidates displayed on the another item input box.

It is preferred that the repair information management apparatus further comprises a repair manual storage for storing a repair manual which is delivered to the terminal. The repair manual is created for each type of the repair description. It is preferred that the repair manual includes video data.

The repair information management system, according to the present invention, for managing repair information of medical equipment comprises terminals located in countries where different languages are used, and a repair information management apparatus having an operation screen distributor for distributing operation screens to the terminals through a network. The repair information is inputted to and displayed on the operation screen. The repair information management apparatus comprises a term correspondence information storage, a term registration request receiver, and a term correspondence information. The term correspondence information storage stores term correspondence information, which allows selecting one of languages used for inputting and displaying the repair information on the operation screen. A term related to the repair information is associated with country-specific terms in the term correspondence information. The country-specific terms are translations of the term related to the repair information in the languages. The term registration request receiver receives a term registration request from the terminal. The term registration request requests registration of a country-specific term in the term correspondence information. The term correspondence information updater updates the term correspondence information based on the term registration request.

The method, according to the present invention, for managing repair information of medical equipment comprises a distribution step, a selection step, a switching step, a receiving step, and an updating step. In the distribution step, operation screens are distributed to terminals through a network. The repair information is inputted to and displayed on the operation screen. The terminals are located in countries where different languages are used. In the selection step, one of languages used for inputting and displaying the repair information is selected. In the switching step, the language used for inputting and displaying the repair information is switched based on the language selected in the selection step and term correspondence information. A term related to the repair information is associated with country-specific terms in the term correspondence table. The country-specific terms are translations of the term related to the repair information in the languages. In the receiving step, a term registration request is received from the terminal. The term registration request requests registration of a country-specific term in the term correspondence information. In the updating step, the term correspondence information is updated based on the term registration request.

According to the present invention, the term correspondence information is updated through terminals located in the countries where different languages are used. In other words, the term correspondence information is updated by the user. Thereby, the multilingual localization is performed properly with less cost and time.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a schematic view illustrating a repair information management system;

FIG. 2 is an explanatory view illustrating repair information;

FIG. 3 is an explanatory view illustrating data stored in a DB;

FIG. 4 is an explanatory view illustrating a code correspondence table;

FIG. 5 is an explanatory view illustrating a step correspondence table;

FIG. 6 is an explanatory view illustrating a term correspondence table;

FIG. 7 is an explanatory view illustrating a user correspondence table;

FIG. 8 is a schematic view of a repair information management apparatus;

FIG. 9 is an explanatory view illustrating processes to select an operation mode;

FIG. 10 is an explanatory view illustrating an operation mode selection screen;

FIG. 11 is an explanatory view illustrating processes in a repair mode;

FIG. 12 is an explanatory view illustrating a repair information input screen;

FIG. 13 is an explanatory view illustrating a repair information input screen in which candidates are narrowed down;

FIG. 14 is an explanatory view illustrating a guide screen;

FIG. 15 is an explanatory view illustrating processes in an edit mode; and

FIG. 16 is an explanatory view illustrating an edit screen.

### DESCRIPTION OF THE PREFERRED EMBODIMENTS

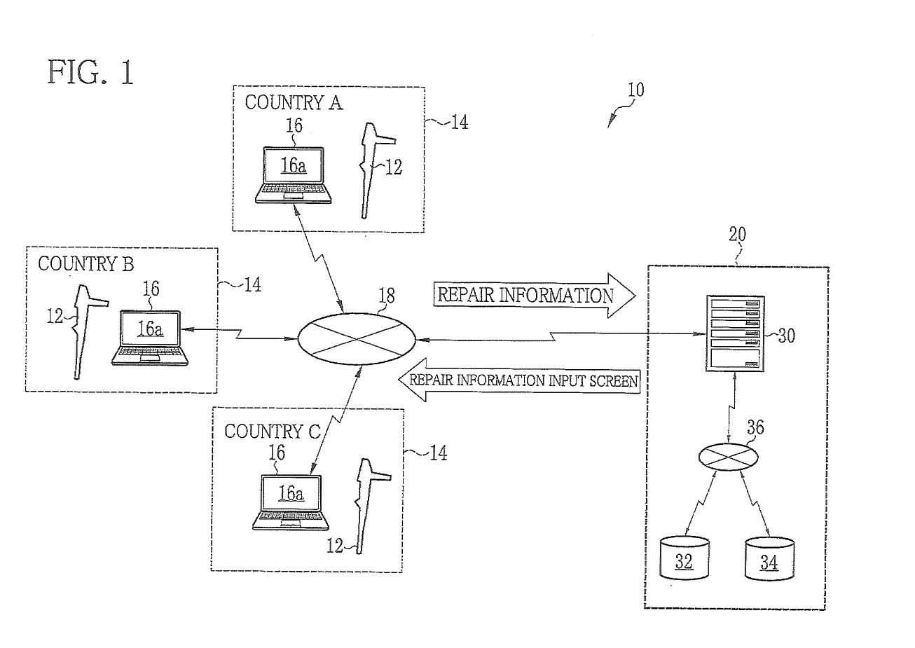

In FIG. 1, a repair information management system 10 is composed of user terminals 16, which are provided in repair centers 14 for endoscopes 12 located in various regions and countries, and a repair information management apparatus 20 connected to each of the user terminals 16 through a network 18 such as the Internet.

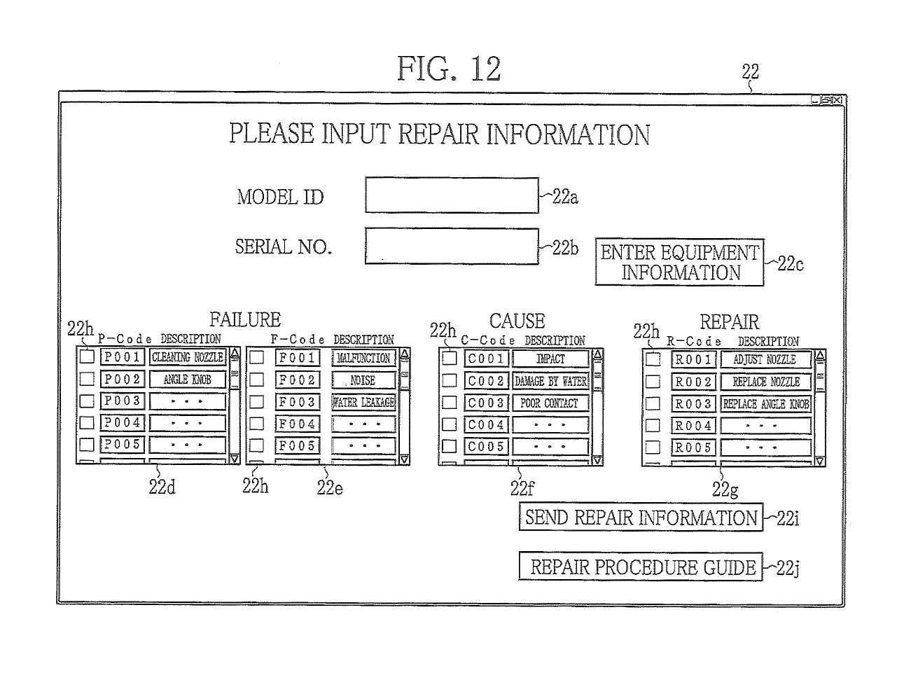

The repair information management system 10 distributes (or delivers) repair information input screens (operation screens) 22 (see FIG. 12) from the repair information management apparatus 20 to the user terminals 16, to collectively manage repair information related to the repairs of the endoscopes 12. The repair information, which includes a faulty part, a failure description, a cause of failure, a repair description, and the like, is transmitted from the user terminal 16 to the repair information management apparatus 20 through the repair information input screen 22.

The repair center 14 is a facility where the faulty endoscope 12 (medical equipment) is repaired. The endoscope 12 which needs repair is sent to the repair center 14 from a client (e.g. a hospital where the endoscope 12 is used) in the region or country in which the repair center 14 is located. After the faulty endoscope 12 is delivered to the repair center 14, the user terminal 16 is operated to access the repair information management apparatus 20. The faulty part, the failure description, analysis of the cause of the failure, and the repair description are determined through the repair information input screen 22, which is delivered by the repair information management apparatus 20. The faulty endoscope 12 delivered to the repair center 14 is repaired as specified by the determined repair description, and then returned to the client.

The user terminal 16 is, for example, a notebook personal computer, and communicates with the repair information management apparatus 20 in accordance with a predetermined communications protocol such as HTTP (Hyper Text Transfer Protocol). Various screens (e.g. the repair information input screen 22) are delivered as web page data from the repair information management apparatus 20 to the user terminal 16. In the web page data, a source code is described with a Hyper Text Markup Language such as XML (Extensible Markup Language), which is used on the WWW (World Wide Web).

Browser software is installed on the user terminal 16, and analyzes and executes the source code. Thereby, the page data of the operation screen delivered to the user terminal 16 is displayed on a display 16a of the user terminal 16. Note that the browser software is a standard one installed on a commercially available personal computer or the like.

The repair information management apparatus 20 is disposed in a company which operates the repair information management system 10. The repair information management apparatus 20 comprises an application server 30 and DBs (databases) 32 and 34, which are connected to each other through a network 36 such as a LAN.

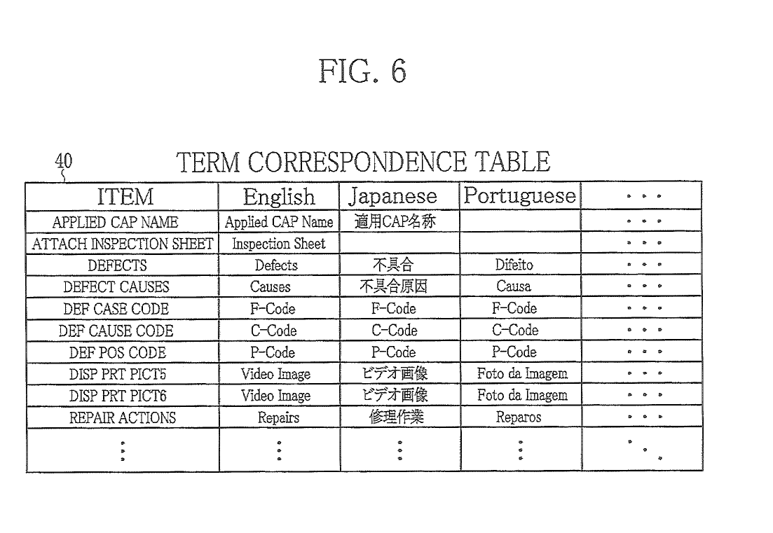

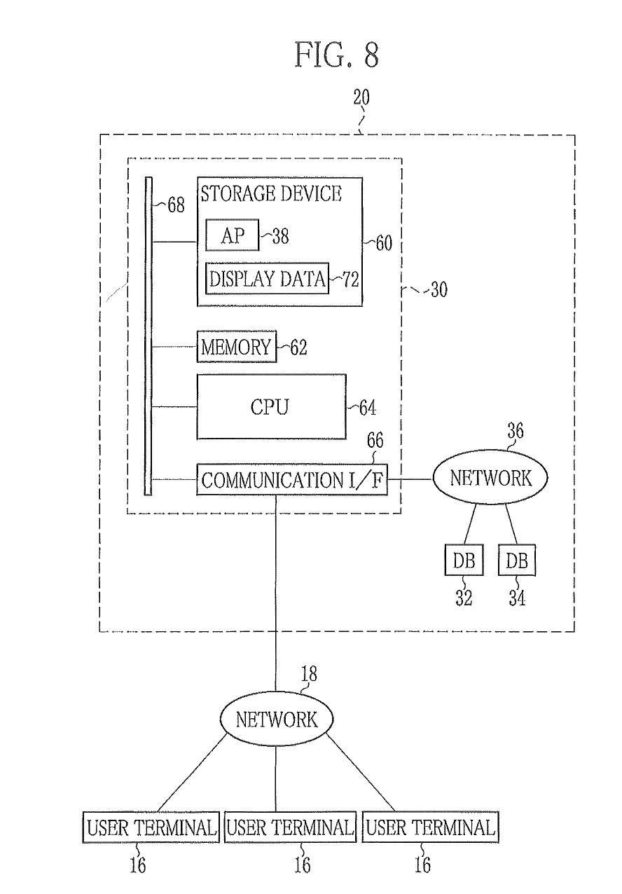

The application server 30 operates in two operation modes, a repair mode and an edit mode, in accordance with an application program (AP) 38 (see FIG. 8), which will be described below. In the repair mode, the repair information input screen 22 is delivered to the user terminal 16, and the repair is performed in accordance with the repair information input screen 22. In the repair mode, the repair information input screen 22 is generated in the language of the user and based on a term correspondence table 40 (see FIG. 6), which will be described below. The repair information input screen 22 allows the user to perform the repair in accordance with the repair information input screen 22 written in his/her own language.

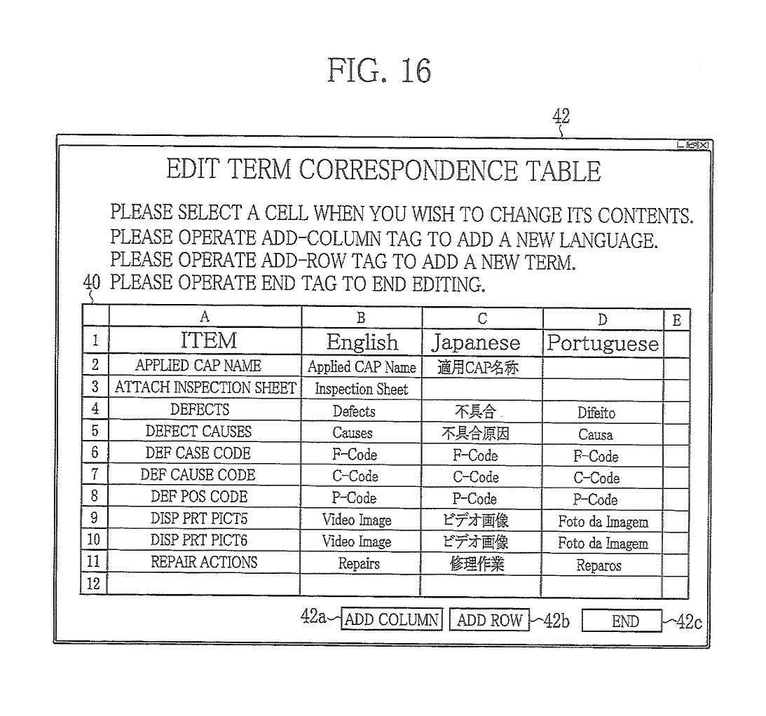

In the edit mode, an edit screen (operation screen) 42 (see FIG. 16) for editing the term correspondence table 40 is delivered to the user terminal 16. The user follows instructions on the edit screen 42 and edits the term correspondence table 40.

Each of the DBs 32 and 34 is composed of a work station and DBMS (Database Management System) installed on the work station. The DB 32 stores the repair information inputted through the repair information input screen 22 displayed on the user terminal 16. The DB 34 stores various types of data which the application server 30 uses in executing various functions in each of the two operation modes (the repair mode and the edit mode).

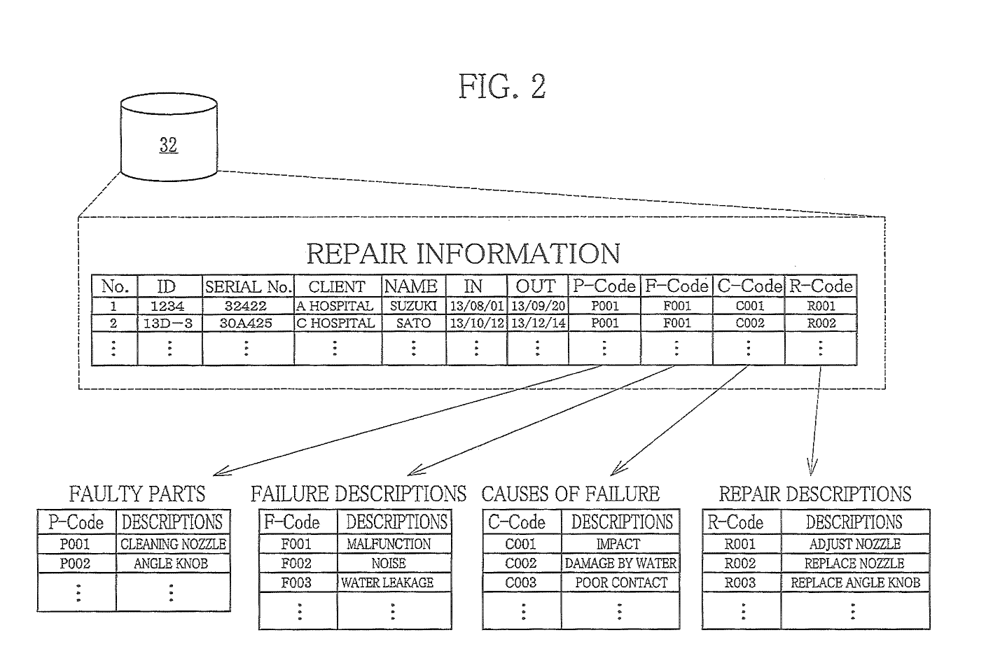

As illustrated in FIG. 2, each piece of the repair information stored in the DB 32 is associated with a model ID and a serial number of the repaired endoscope 12, the name of the client (or organization) who requested the repair, the name of the person who performed the repair, the date (denoted as “IN” in FIG. 2) of receiving the endoscope 12 to be repaired, the date (denoted as “OUT” in FIG. 2) of completion of the repair, a “P-Code” indicating a faulty part, an “F-code” indicating a failure description, a “C-code” indicating a cause of the failure, and an “R-code” indicating a repair description. A piece of repair information is generated for each repair and stored in the DB 32.

The “P-Code” refers to a code which corresponds to information indicating a faulty part. The plurality of P-Codes are provided in association with parts of the endoscope 12 (e.g. a cleaning nozzle that ejects a cleaning liquid to clean a distal portion of an insertion section of the endoscope 12, and an angle knob, being a knob with a dial, used for bending the insertion section of the endoscope 12), respectively.

The “F-Code” refers to a code which corresponds to information indicating a failure description. The plurality of F-codes are provided in association with various types of possible failure descriptions (e.g. malfunction, noise in an image, and water leakage), respectively.

The “C-Code” refers to a code which corresponds to information indicating a cause of a failure. The plurality of C-codes are provided in association with a plurality of possible causes (e.g. application of impact, damage due to water, and poor contact), respectively.

The “R-Code” refers to a code which corresponds to information indicating a repair description. The plurality of R-codes are provided in association with the possible repair descriptions (e.g. adjusting the cleaning nozzle, replacing the cleaning nozzle, and replacing the angle knob), respectively.

As described above, the repair information management system 10 uses common codes for describing the repair information (the faulty part, the failure description, the cause of the failure, the repair description), which are not dependent on any specific language. As compared with the case in which the repair information is described in different languages, the load on the application server 30 is reduced and compilation and statistical processes of the repair information are easy even after the localization because the repair information is managed by using the codes, which overcome the differences in languages.

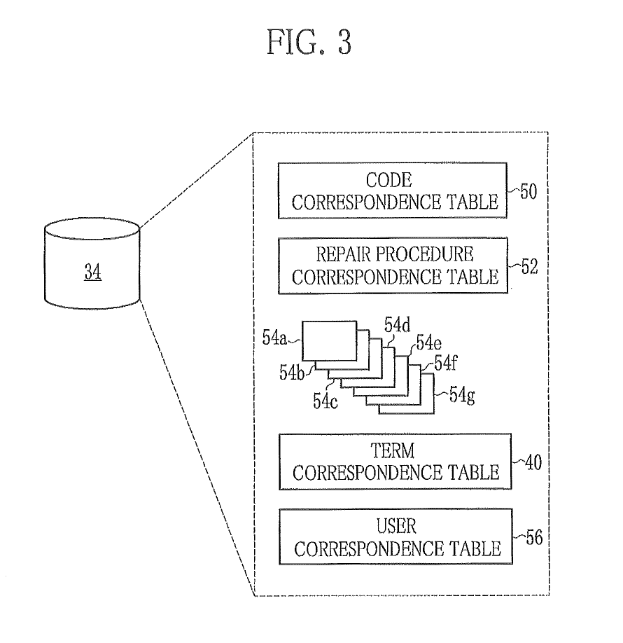

As illustrated in FIG. 3, the DB 34 stores the data which the application server 30 uses in executing the various functions. The data stored in the DB 34 includes a code correspondence table 50, a repair procedure correspondence table 52, guide videos 54a to 54g, the term correspondence table 40, and a user correspondence table 56.

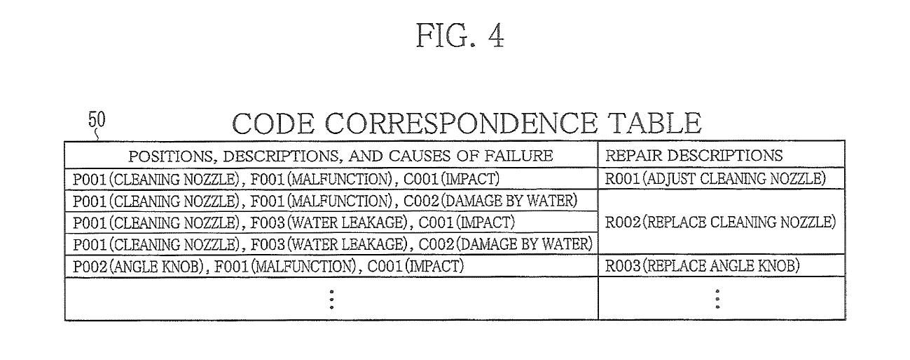

As illustrated in FIG. 4, in the code correspondence table 50, each “R-code (code for repair description or repair description code)” is associated with at least one combination of three types of codes: the “P-Code (the faulty part)”, the “F-Code (the failure description)”, and the “C-Code (the cause of the failure)”. The code correspondence table 50 is used for a “refined search” for narrowing down possible candidates (choices) for the code of one type, by the code of another type.

In this embodiment, the repair description code “R001 (adjust the cleaning nozzle)” is associated with the combination of the three codes “P001 (cleaning nozzle)”, “F001 (malfunction)”, and “C001 (application of impact)”, by way of example.

The repair description code “R002 (replace the cleaning nozzle)” is associated with the combination of “P001 (the cleaning nozzle)”, “F001 (malfunction)”, and “C002 (damage due to water)”, the combination of “P001 (the cleaning nozzle)”, “F003 (water leakage)”, and “C001 (application of impact)”, and the combination of “P001 (the cleaning nozzle)”, “F003 (water leakage)”, and “C002 (damage due to water)”, by way of example.

The repair description code “R003 (replace the angle knob)” is associated with the combination of “P002 (angle knob)”, “F001 (malfunction)”, and “C001 (application of damage)”, by way of example.

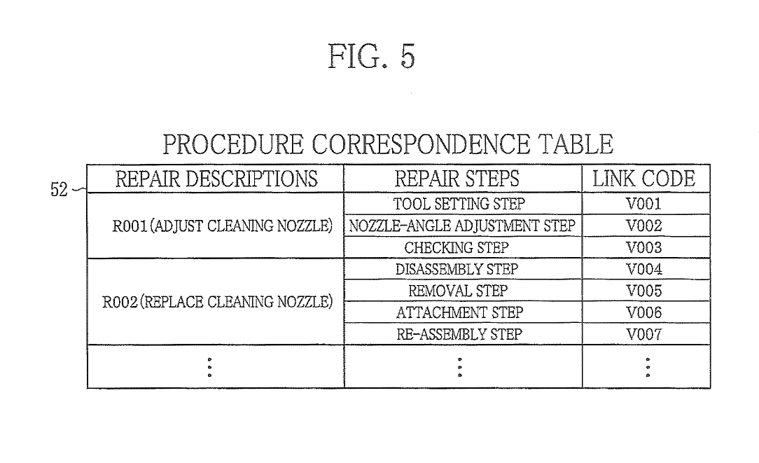

As illustrated in FIG. 5, in the repair procedure correspondence table 52, each “R-Code (repair description)” is associated with the corresponding repair procedure for performing the repair. The repair procedure correspondence table 52 is consulted to determine the repair procedure from the “R-Code (the repair description)”. Here, a single repair procedure is composed of two or more repair steps (or simply referred to as the steps). To be more specific, for example, a repair procedure for replacing a faulty part includes a step for disassembling parts surrounding the faulty part to expose the faulty part, a step for re-assembling the parts after the replacement (or disassembly), and a step for checking the operation after the replacement. The repair procedure correspondence table 52 groups the steps included in each repair procedure and manages the group as a series of steps.

To be more specific, in the repair procedure correspondence table 52, the repair procedure (hereinafter referred to as “the cleaning nozzle adjustment procedure”) corresponding to “R001 (adjusting the cleaning nozzle)” is associated with the combination of three steps: a “tool setting step”, a “nozzle-angle adjustment step”, and a “checking step”. In the tool setting step, a special tool for adjusting the cleaning nozzle is set to the cleaning nozzle. In the nozzle-angle adjustment step, the special tool set to the cleaning nozzle is used to adjust the angle of the cleaning nozzle. In the checking step, a cleaning liquid is ejected through the cleaning nozzle to see whether the cleaning nozzle works properly after the adjustment of the nozzle angle.

In the repair procedure correspondence table 52, the repair procedure (hereinafter referred to as the “cleaning nozzle replacement procedure”) corresponding to “R002 (replacing the cleaning nozzle)” is associated with the combination of four steps: a “disassembly step”, a “removal step”, an “attachment step”, and a “re-assembly step”. In the disassembly step, the distal portion of the endoscope is disassembled. In the removal step, the faulty cleaning nozzle is removed from the disassembled distal portion of the endoscope. In the attachment step, a new cleaning nozzle is attached to the distal portion. In the re-assembly step, the disassembled distal portion is re-assembled.

Note that, after the replacement of the cleaning nozzle, it is preferred to adjust the new cleaning nozzle, so that “cleaning nozzle adjustment procedure (code: R001)” may be included in “cleaning nozzle replacement procedure (code: R002)”. In this case, the cleaning nozzle replacement procedure (code: R002)” is associated with the total of seven steps, in which the three steps (the “tool setting step”, the “nozzle-angle adjustment step”, and the “checking step”) constituting the “the cleaning nozzle adjustment procedure” are added to the above-described four steps (the “disassembly step”, the “removal step”, the “attachment step”, and the “re-assembly step”). Instead, a part of the steps constituting the “cleaning nozzle adjustment procedure”, for example, only the “checking step” may be added to the “cleaning nozzle replacement procedure”. Thus, the contents and details of the repair procedure correspondence table 52 are changed as appropriate.

In the repair procedure correspondence table 52, link codes “V001” to “V007” are associated with the seven steps (i.e. the three steps constituting the “cleaning nozzle adjustment procedure” and the four steps constituting the “cleaning nozzle replacement procedure”), respectively. The link codes “V001” to “V007” indicate link destinations (i.e. the guide videos 54a to 54g, which support the repair descriptions in the respective steps.), respectively. The guide videos 54a to 54g are movie data obtained by capturing moving images of actual repair actions (operations) in the corresponding steps.

As illustrated in FIG. 6, in the term correspondence table 40, each term (word) to be displayed on the repair information input screen 22 is associated with country-specific terms that are translations of the term (word) in different languages. Based on the term correspondence table 40, the language displayed on the repair information input screen 22 is switched, which will be described below. In other words, the repair information input screen 22 is displayed in one of the languages listed in the term correspondence table 40.

Note that each term code that is a code indicating information of a corresponding term may be associated with the country-specific terms, and stored in the term correspondence table 40, in a manner similar to the above. Managing the terms in codes makes it easy to perform the compilation and statistical processes of the repair information even after the localization.

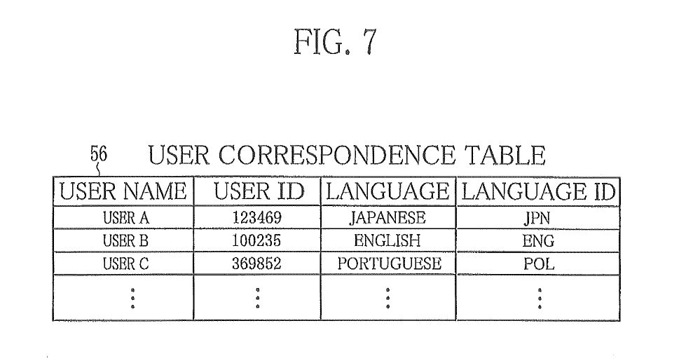

In FIG. 7, in the user correspondence table 56, each user is assigned a user ID, the language the user uses, and a language ID of the language. The user ID is automatically assigned to the user in accordance with predetermined rules after required items (the name of the user, the branch or department to which the user belongs, a contact address of the user, and the like) are inputted through the user terminal 16 in a user registration process, which is performed with the user's first access to the repair information management system 10. In the user registration process, the user is asked to select one of the languages to be used in using the repair information management system 10, from those listed in the term correspondence table 40. The language ID of the language selected by the user is assigned to (or stored in) the user correspondence table 56.

Note that the area in which the user terminal 16 accessing the application server 30 is located may be determined by the IP address or the like of the user terminal 16, and the language used in the identified area may be automatically assigned as the display language to the user correspondence table 56. The contents or items (e.g. the display language and the like) set (or registered) in the user registration process may be changed at or after the second access to the repair information management system 10.

As illustrated in FIG. 8, the application server 30 is composed of the computer (e.g. a personal computer or a work station) and programs, such as a control program (e.g. an operating system) and the AP 38, installed on the computer. The AP 38 allows the computer to execute various functions and to function as the application server 30.

The application server 30 comprises a storage device 60, a memory 62, a CPU 64, and a communication I/F 66, which are connected to each other through a data bus 68. The storage device 60 is, for example, a hard disk drive, which is an internal storage incorporated in a body of the application server 30.

The storage device 60 stores the control program, the AP 38 such as the software for the application server, images and messages displayed during the execution of the AP 38, and display data 72 used for displaying an operation mode selection screen (the operation screen) 70 (see FIG. 10), the repair information input screen 22, and the edit screen 42. Note that the display data 72 includes template information, being the base for generating the operation mode selection screen 70, the repair information input screen 22, and the edit screen 42.

The memory 62 is a working memory used by the CPU 64 to execute the processes. The CPU 64 loads the control program, which is stored in the storage device 60, onto the memory 62 and executes the processes in accordance with the control program. Thereby, the CPU 64 centrally controls each section of the computer. The communication I/F 66 comprises an interface to communicate with the networks 18 and 36. The application server 30 communicates with the DBs 32 and 34 and the user terminal 16 through the communication I/F 66 and the networks 18 and 36.

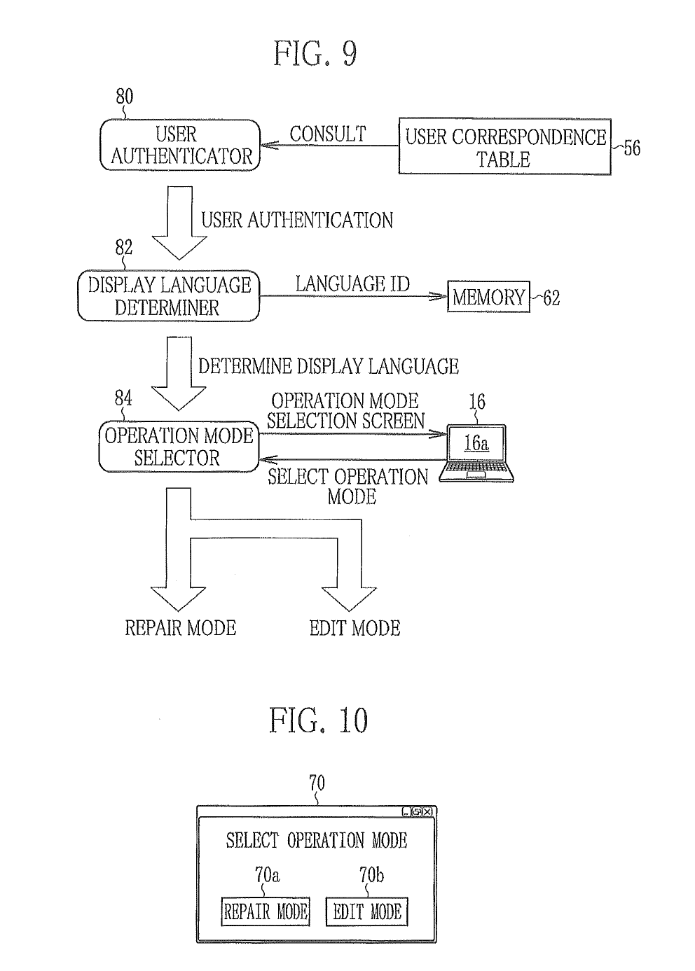

As illustrated in FIGS. 9, 11, and 15, when the AP 38 is started, the CPU 64, working together with the memory 62, functions as a user authenticator 80, a display language determiner 82, an operation mode selector 84, a repair information input screen generator 86, a repair information input screen distributor 88, a repair information updater 90, a repair procedure guide section 92, and a term correspondence table updater 94.

As illustrated in FIG. 9, the user authenticator 80 receives a request (access request) to access the repair information management system 10 from the user terminal 16, and performs user authentication. The access request is transmitted to the user authenticator 80 when the company which operates the repair information management system 10 inputs the user ID to its web site on the network 18, for example. Upon receiving the access request, the user authenticator 80 verifies the user ID, which is inputted together with the access request, against the user correspondence table 56, and thereby authenticates the user. Note that the user may be required to input a password in addition to the user ID at the time of the user authentication. In this case, the user authenticator 80 authenticates the user through the user ID and the password.

After the user authentication is completed, the display language determiner 82 is activated. The display language determiner 82 verifies the user ID of the authenticated user against the user correspondence table 56, and determines the language which corresponds to the language ID associated with the user ID to be the language displayed in the subsequent screens. The display language determiner 82 allows the memory 62 to store the language ID of the language thus determined.

After the determination of the display language is completed, the operation mode selector 84 is activated. Upon the activation, the operation mode selector 84 generates the operation mode selection screen 70 illustrated in FIG. 10, and delivers the operation mode selection screen 70 to the user terminal 16. The operation mode selection screen 70 is provided with an operation tag 70a, which allows the application server 30 to operate in the repair mode, and an operation tag 70b, which allows the application server 30 to operate in the edit mode. The user operates the user terminal 16 and selects one of the operation tags 70a and 70b. Thus, the user selects to operate the application server 30 in the repair mode or the edit mode.

Note that the operation mode selection screen 70 illustrated in FIG. 10 is displayed in English by way of example. In a case where the display language determiner 82 stores the language ID of the language other than English in the memory 62, the operation mode selection screen 70 is displayed in the language which is determined by the language ID stored by the display determiner 70. The operation mode selector 84 generates the operation mode selection screen 70 based on the language ID which is stored in the memory 62 by the display language determiner 82, the term correspondence table 40, and the template information stored in the storage device 60, and with the use of the country-specific terms of the language which corresponds to the language ID.

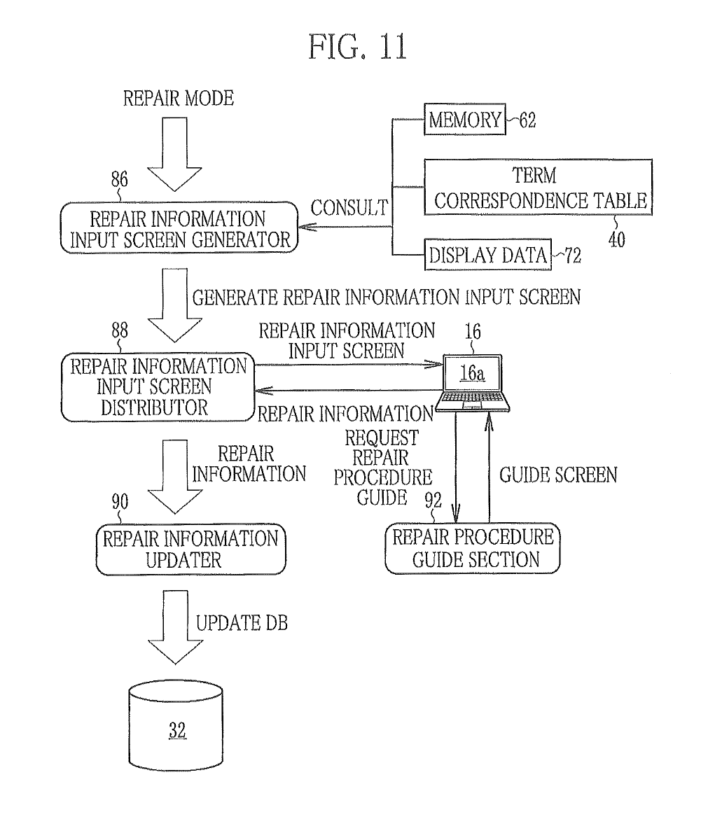

As illustrated in FIG. 11, when the repair mode is selected through the operation mode selection screen 70, in other words, when the operation tag 70a is operated on the operation mode selection screen 70, the repair information input screen generator 86, the repair information input screen distributor 88, and the repair information updater 90 are activated.

The repair information input screen generator 86 generates the repair information input screen 22 based on the language ID which is stored in the memory 62 by the display language determiner 82, the term correspondence table 40, and the template information stored as the display data 72 in the storage device 60, and with the use of the country-specific terms of the language which corresponds to the language ID. The repair information input screen distributor 88 delivers the repair information input screen 22, which is generated by the repair information input screen generator 86, to the user terminal 16.

As illustrated in FIG. 12, the repair information input screen 22 is provided with a model ID input box 22a, to which a model ID of the endoscope 12 to be repaired is inputted, and a serial number input box 22b, to which a serial number of the endoscope 12 is inputted. After the model ID and the serial number are inputted to the respective input boxes 22a and 22b, an enter tag (confirmation tag) 22c is operated. Thereby, the endoscope 12 to be repaired is identified. The codes displayed in the following input boxes are narrowed down to those corresponding to the endoscope 12 to be repaired.

The repair information input screen 22 is provided with a faulty part input box 22d, to which a faulty part is inputted, a failure description input box 22e, to which a failure description is inputted, a cause input box 22f, to which a cause of the failure is inputted, and a repair description input box 22g, to which a repair description is inputted. The faulty part input box 22d is provided to allow the user to input (or select) the actual faulty part from the list of the parts denoted by the “P-Codes (the faulty parts)”. The faulty part input box 22d displays the list of the selectable “P-Codes (the faulty parts)” and their descriptions. A check box 22h is provided to the side of each code number in the faulty part input box 22d. The faulty part is inputted by selecting one of the check boxes 22h.

The failure description input box 22e displays the list of the possible “F-Codes (the failure descriptions)” and the corresponding descriptions. The failure description is inputted by selecting one of the check boxes 22h. The cause input box 22f displays the list of the possible “C-Codes (the causes of the failure)” and the corresponding descriptions. The cause of the failure is inputted by selecting one of the check boxes 22h. The repair description input box 22g displays the list of the possible “R-Codes (the repair descriptions)” and the corresponding descriptions. The repair description is inputted by selecting one of the check boxes 22h.

The repair information input screen distributor 88 monitors the presence or absence of input to the input boxes 22d to 22g. When information is inputted to one of the input boxes, the repair information input screen distributor 88 uses the input information as a search key and performs the refined search to narrow down the candidates to be displayed in the rest of the input boxes. To be more specific, the repair information input screen distributor 88 consults the code correspondence table 50, and displays only the code numbers (possible candidates), which are associated with the search key (the input information), in each input box.

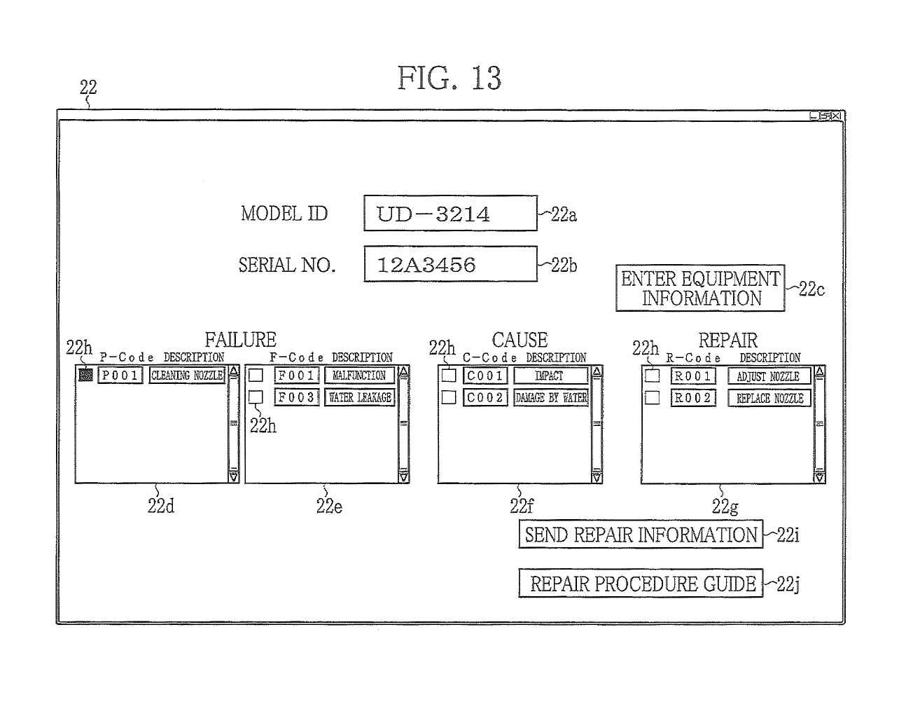

For example, the faulty part “P001 (the cleaning nozzle)” is inputted to the input box 22d as illustrated in FIG. 13 in a state where no information is inputted to the rest of the input boxes 22e to 22g as illustrated in FIG. 12. In this case, the codes corresponding to the failure description, the cause of the failure, and the repair description, which are associated with “P001 (the cleaning nozzle)”, are extracted from the code correspondence table 50 (see FIG. 4) and displayed in the input boxes 22e to 22g.

In this example, the failure descriptions associated with “P001 (the cleaning nozzle)” are “F001 (malfunction)” and “F003 (water leakage)”, so that these codes (F001 and F003) are displayed as the possible candidates for the failure descriptions in the input box 22e. The causes of the failure associated with “P001 (the cleaning nozzle)” are “C001 (application of impact)” and “C002 (damage due to water)”, so that these codes (C001 and C002) are displayed as the possible candidates for the causes of the failure in the input box 22f. The repair descriptions associated with “P001 (the cleaning nozzle)” are “R001 (adjust the cleaning nozzle)” and “R002 (replace the cleaning nozzle)”, so that these codes (R001 and R002) are displayed as the possible candidates for the repair descriptions in the input box 22g.

The repair information input screen distributor 88 narrows down the candidates every time a new piece of information is inputted to one of the input boxes 22d to 22g, following the steps described above. In other words, in a case where “F003 (water leakage)” is selected as the failure description in the input box 22e in the state illustrated in FIG. 13, “C001 (application of impact)” and “C002 (damage due to water)”, each of which is associated with both “F003 (water leakage)” and “P001 (the cleaning nozzle)”, are displayed as the possible candidates for the causes of the failure in the input box 22f. Furthermore, “R002 (replacing the cleaning nozzle)” associated with both “F003 (water leakage)” and “P001 (the cleaning nozzle)” is displayed as the possible candidate for the repair description in the input box 22g.

As described above, the repair information is inputted to the repair information input screen 22 based on the language-independent codes, “F-Codes”, “C-Codes”, and “R-Codes”, which are commonly used irrespective of the language used. The codes contribute to standardization of the collected repair information and prevent errors in operation and input. In other words, problems such as variation in input information from person to person (even with the same repair information) are reduced. Since the repair information is selected from the narrowed down candidates, errors in operation and input are prevented securely and the repair information is inputted efficiently.

After the information is inputted to each of the input boxes 22a to 22g on the repair information input screen 22, a repair information transmission tag 22i is activated. In response to the operation of the repair information transmission tag 22i, the repair information inputted to the input boxes 22a to 22g is transmitted to the repair information updater 90. The repair information updater 90 receives the repair information and stores the repair information in the DB 32, and thereby updates the DB 32.

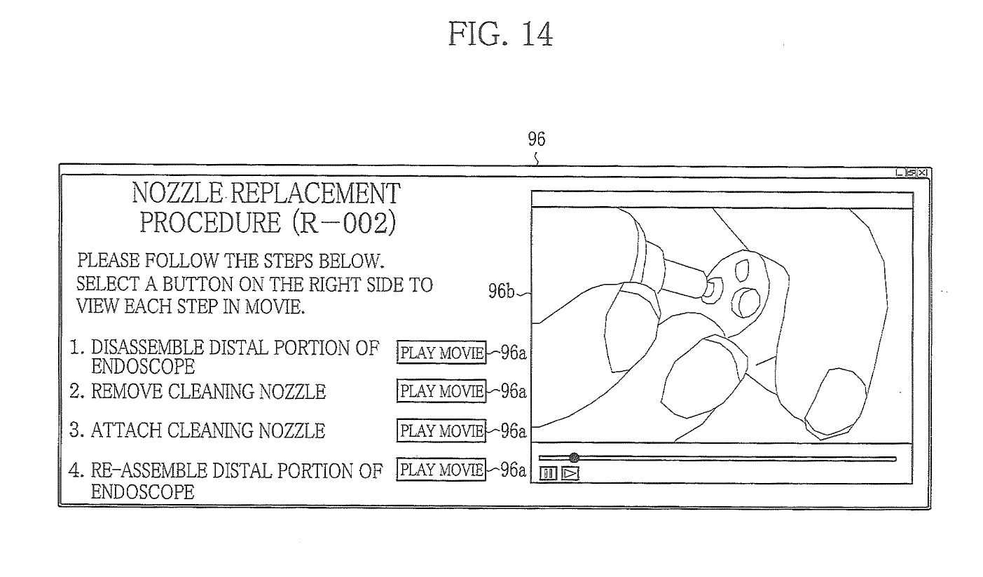

When the repair description is inputted to the repair information input screen 22, a repair procedure guide tag 22j is activated. In response to the operation of the repair procedure guide tag 22j, a repair procedure guide request is inputted to the repair procedure guide section 92. Upon receiving the repair procedure guide request, the repair procedure guide section 92 extracts the repair procedure, which corresponds to the “R-Code (the repair description)” inputted through the repair information input screen 22, from the repair procedure correspondence table 52 and generates a guide screen 96 (see FIG. 14). The guide screen 96 guides each action (the repair step) in the extracted repair procedure. The repair procedure guide section 92 delivers the guide screen 96 to the user terminal 16.

As illustrated in FIG. 14, the guide screen 96 displays a list of the repair steps, which correspond to the “R-Code (the repair description)” inputted through the repair information input screen 22. The guide screen 96 is also provided with link tags 96a and a display section 96b in which a guide video is displayed by the operation of the link tag 96a. The link tags 96a are linked to the guide videos which correspond to the repair steps, respectively. When the link tag 96a on the guide screen 96 is operated, information indicating that the link tag 96a has been operated is inputted to the repair procedure guide section 92. The repair procedure guide section 92 reads out the guide video which corresponds to the inputted link tag 96a from the DB 34, and displays the guide video in the display section 96b.

As described above, the guide screen 96 displays the repair steps and the guide videos 54a to 54g to guide the user through the respective repair steps. Thus, the repair operations are performed efficiently. Since the videos (movies) are independent of differences in language and help the user to intuitively understand the details of the repair actions (operations), the movies are shared by the users in many countries and regions. Thus, the above-described movies are efficiently used as compared with the movies in different languages provided on a country-by-country basis or a region-by-region basis.

Note that the above example is described based on the premise that the user himself/herself repairs the endoscope, and the user's repair actions are assisted. Alternatively, the user may determine the repair description by the use of the repair information input screen 22, and then the user may ask a repair facility to repair the endoscope based on the determined repair description. In this case, for example, the AP 38 allows the CPU 64 of the application server 30 to function as a repair request sender. After the repair description is determined on the repair information input screen 22, the repair request sender is activated. The repair request sender sends a repair request in a predetermined form such as an e-mail, with the data related to the determined repair description, to a predetermined destination such as the repair facility. In the case where the user asks a third party for the repair, a repair fee may be displayed when the repair description is inputted.

Up to this point, we have described the operation of the application server 30 in the repair mode. Next, an operation of the application server 30 in the edit mode is described.

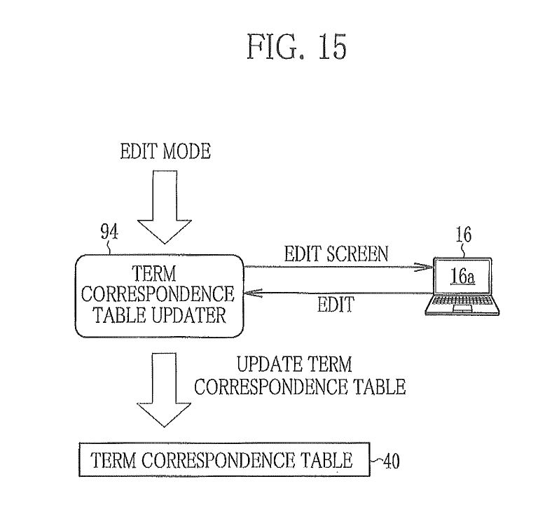

As illustrated in FIG. 15, in a case where the edit mode is selected through the operation mode selection screen 70, in other words, in a case where the operation tag 70b on the operation mode selection screen 70 is operated, the term correspondence table updater 94 is activated. Upon the activation, the term correspondence table updater 94 generates the edit screen 42 for editing the term correspondence table 94, and delivers the edit screen 42 to the user terminal 16.

As illustrated in FIG. 16, the term correspondence table 40, which is composed of rows and columns of cells, is displayed on the edit screen 42. The user selects a cell to change its contents. The edit screen 42 is provided with an “add-column” tag 42a, an “add-row” tag 42b, and an end tag 42c. The add-column tag 42a is provided to add a new language or a new country-specific term. In response to the operation of the add-column tag 42a, a request for adding a new column of cells, which extends in the vertical direction of the term correspondence table 40, is transmitted from the user terminal 16 to the term correspondence table updater 94. Upon receiving the request, the term correspondence table updater 94 adds a new column to the term correspondence table 40. The user adds a new language or a new country-specific term to the added column. The add-row tag 42b is provided to add a new term (word) or a new country-specific term. In response to the operation of the add-row tag 42b, a request for adding a new row of cells, which extends in the horizontal direction of the term correspondence table 40, is transmitted from the user terminal 16 to the term correspondence table updater 94. Upon receiving the request, the term correspondence table updater 94 adds a new row to the term correspondence table 40. The user adds a new term or a new country-specific term to the added row. The end tag 42c is operated to end editing of the term correspondence table 40. In response to the operation of the end tag 42c, the changes made on the edit screen 42 are accepted. The term correspondence table updater 94 changes (or updates) the term correspondence table 40 to reflect the accepted changes.

As described above, the term correspondence table 40 is changed (or updated) through the user terminal 16, so that the multilingual localization is performed as appropriate with less cost and time.

Note that, in the present invention, the details of the embodiments are not limited to the above and may be changed as appropriate, as long as the term correspondence table is updated by the user. In the above-described examples, the application server is provided to the repair information management apparatus. The user views the various screens, offered by the application server, on the user terminal through the browser. The AP may be installed on the user terminal to allow the CPU of the user terminal to function as the application server.

The database (DB) is provided to the information management apparatus by way of example. Instead or in addition, a storage device (hard disk) of the user terminal may function as the database.

Any user is allowed to update the term correspondence table by way of example. Alternatively, authorization may be given on a user-by-user basis, and only some of the users may be authorized to update the term correspondence table. In this case, in the user correspondence table, the user ID is associated with authorization information (authorization ID or the like) that indicates the authorization given to the user. The term correspondence table updater distributes the edit screens for editing the term correspondence table only to the authorized users.

The term correspondence information is tabulated in the term correspondence table by way of example. The data format of the term correspondence information is not limited to the tabulated form and may be changed freely. The user ID is used as the identification information for determining the language used, by way of example. The identification information for determining the language may be other than the user ID, for example, a country code or a terminal ID.

The term correspondence information in which the terms (words) are listed on a country-by-country basis is used by way of example. There are cases where different languages are used in different regions in one country. In consideration of this, a term correspondence table may be generated on a region-by-region basis, a language-by-language basis, or in any other form, as long as each term (word) related to the repair information is translated into different languages and each of the translations (translated words) is associated with the original term related to the repair information.

The repair manuals for guiding the repairs are created and distributed in the form of movie data, by way of example. The repair manuals may be document data.

The present invention is applied to the repair information management system for managing the repair information of the endoscopes by way of example, and may be applied to a repair information management system for managing repair information of medical equipment other than the endoscopes.

Various changes and modifications are possible in the present invention and may be understood to be within the present invention.

What is claimed is:

1. A repair information management apparatus for managing repair information of medical equipment, comprising:
an operation screen distributor for distributing operation screens through a network to terminals located in countries where different languages are used, the repair information being inputted to and displayed on the operation screen;
a term correspondence information storage for storing a term correspondence information allowing selecting one of languages used for inputting and displaying the repair information on the operation screen, a term related to the repair information being associated with country-specific terms in the term correspondence information, the country-specific terms being translations of the term related to the repair information in the languages;
a registration request receiver for receiving a term registration request for registering a country-specific term in the term correspondence information from the terminal; and
a term correspondence information updater for updating the term correspondence information based on the term registration request.

2. The repair information management apparatus according to claim 1, further comprising:
a language determiner for determining the language used on the operation screen, based on identification information transmitted from the terminal; and
an operation screen generator for consulting the term correspondence information storage and generating the operation screen with the use of the country-specific terms corresponding to the determined language.

3. The repair information management apparatus according to claim 2, further comprising a user language correspondence information storage for storing user language correspondence information, a user ID assigned to a user using the terminal being associated with a language ID indicating the language in the user language correspondence information,
wherein the language determiner determines the language based on the user ID inputted as the identification information.

4. The repair information management apparatus according to claim 2, further comprising:
a repair information receiver for receiving the repair information through the network, the repair information being inputted through the operation screen of the terminal; and
a repair information storage for storing the received repair information.

5. The repair information management apparatus according to claim 4, wherein the repair information includes at least one of items: a faulty part, a failure description, a cause of a failure, and a repair description of the medical equipment.

6. The repair information management apparatus according to claim 5, wherein the each term is assigned a code and the each term is associated with the country-specific terms and the code in the term correspondence information.

7. The repair information management apparatus according to claim 6, wherein the repair information is a piece of information which includes each of the items: the faulty part, the failure description, the cause of the failure, and the repair description, and the each item is stored together with one of the codes.

8. The repair information management apparatus according to claim 7, wherein the operation screen is provided with an item input box to which one of the items is inputted.

9. The repair information management apparatus according to claim 8, further comprising:
a candidate storage for storing in advance the terms to be displayed as possible candidates for the item input boxes, the possible candidates of the different item input boxes being associated with each other in the candidate storage; and
a refined search section for searching through the candidate storage with a search key, being the term inputted to one of the item input boxes, and narrowing down the candidates displayed on the another item input box.

10. The repair information management apparatus according to claim 7, further comprising:
a repair manual storage for storing a repair manual which is delivered to the terminal, the repair manual being created for each type of the repair description.

11. The repair information management apparatus according to claim 10, wherein the repair manual includes video data.

12. A repair information management system for managing repair information of medical equipment, comprising:
terminals located in countries where different languages are used;
a repair information management apparatus having an operation screen distributor for distributing operation screens to the terminals through a network, the repair information being inputted to and displayed on the operation screen, the repair information management apparatus comprising:
a term correspondence information storage for storing term correspondence information allowing selecting one of languages used for inputting and displaying the repair information on the operation screen, a term related to the repair information being associated with country-specific terms in the term correspondence information, the country-specific terms being translations of the term related to the repair information in the languages;
a term registration request receiver for receiving a term registration request from the terminal, the term registration request requesting registration of a country-specific term in the term correspondence information: and
a term correspondence information updater for updating the term correspondence information based on the term registration request.

13. A method for managing repair information of medical equipment, comprising the steps of:
(a) distributing operation screens to terminals through a network, the repair information being inputted to and displayed on the operation screen, the terminals being located in countries where different languages are used;
(b) allowing selecting one of languages used for inputting and displaying the repair information;
(c) switching the language used for inputting and displaying the repair information, based on the language selected in the step (b) and term correspondence information, a term related to the repair information being associated with country-specific terms in the term correspondence table, the country-specific terms being translations of the term related to the repair information in the languages;
(d) receiving a term registration request from the terminal, the term registration request requesting registration of a country-specific term in the term correspondence information; and
(e) updating the term correspondence information based on the term registration request.
